(19) United States
(12) Patent Application Publication
(10) Pub. No.: US 2014/0115579 A1
(43) Pub. Date: Apr. 24, 2014

(54) Datacenter storage system

(71) Applicant: Jonathan Kong, Thousand Oaks, CA (US)

(72) Inventor: Jonathan Kong, Thousand Oaks, CA (US)

(21) Appl. No.: 13/694,001

(22) Filed: Oct. 19, 2012

(51) Int. Cl. G06F 9/455

(52) U.S. Cl. 718/1

(57) ABSTRACT

A storage hypervisor having a software defined storage controller (SDSC) provides for a comprehensive set of storage control, virtualization and monitoring functions to decide the placement of data and manage functions such as availability, automated provisioning, data protection and performance acceleration. The SDSC running as a software driver on the server replaces the hardware storage controller function, virtualizes physical disks in a cluster into virtual building blocks and eliminates the need for a physical RAID layer, thus maximizing configuration flexibility for virtual disks. This configuration flexibility consequently enables the storage hypervisor to optimize the combination of storage resources, data protection levels and data services to efficiently achieve the performance, availability and cost objectives of individual applications. This invention enables complex SAN infrastructure to be eliminated without sacrificing performance, and provides more services than prior art SAN with fewer components, lower costs and higher performance.

### CROSS-REFERENCE TO RELATED APPLICATIONS

The present application claims priority to U.S. Provisional Patent Application No. 61/690,201, filed on Jun. 21, 2012, entitled “STORAGE HYPERVISOR” which is incorporated by reference in its entirety.

### BACKGROUND OF THE INVENTION

1. Field of the Invention

The present invention relates generally to management of computer resources, and more specifically, to management of storage resources in data centers.

2. Description of the Background Art

A conventional datacenter typically includes three or more tiers (namely, a server tier, network tier and a storage tier) consisting of physical servers (sometimes referred to as nodes), network switches, storage systems and two or more network protocols. The server tier typically includes multiple servers that are dedicated to each application or application portion. Typically, these servers provide a single function (e.g., file server, application server, backup server, etc.) to one or more client computers coupled through a communication network. A server hypervisor, also known as a virtual machine monitor (VMM) is utilized on most servers. The VMM performs server virtualization to increase utilization rates for server resources and provide management flexibility by de-coupling servers from the physical computer hardware. Server virtualization enables multiple applications, each in an individual virtual machine, to run on the same physical computer. The provides significant cost savings since fewer physical computers are required to support the same application workload.

The network tier is composed of a set of network segments connected by network switches. The network tier typically includes a communication network used by client computers to communicate with servers and for server-to-server communication in clustered applications. The network tier also includes a separate, dedicated storage area network (hereinafter “SAN”) to connect servers to storage systems. The SAN provides a high performance, low latency network to support input/output requests from applications running on servers to storage systems housing the application data. The communication network and storage area network or SAN typically run different network protocols requiring different skill sets and people with the proper training to manage each network.

The storage tier typically includes a mix of storage systems based on different technologies including network attached storage (hereinafter “NAS”), block based storage and object based storage devices (hereinafter “OSD”). NAS systems provide file system services through a specialized network protocols while block based storage typically presents storage to servers as logical unit numbers (LUNs) utilizing some form of SCSI protocol. OSD systems typically provide access to data through a key-value pair approach which is highly scalable. The various storage systems include physical disks which are used for permanent storage of application data. The storage systems add data protection methods and services on top of the physical disks using data redundancy techniques (e.g. RAID, triple copy) and data services (e.g. snapshots and replication). Some storage systems support storage virtualization features to aggregate the capacity of the physical disks within the storage system into a centralized pool of storage resources. Storage virtualization provides management flexibility and enables storage resources to be utilized to create virtual storage on demand for applications. The virtual storage is accessed by applications running on servers connected to the storage systems through the SAN.

When initially conceived, SAN architectures connected non-virtualized servers to storage systems which provided RAID data redundancy or were simple just-a-bunch of disks (JBOD) storage systems. Refresh cycles on servers and storage systems were usually three to five years and it was rare to repurpose systems for new applications. As the pace of change grew in IT datacenters and CPU processing density significantly increased, virtualization techniques were introduced at both the server and storage tiers. The consolidation of servers and storage through virtualization brought improved economy to the IT datacenters but it also introduced a new layer of management and system complexity.

Server virtualization creates challenges for SAN architectures. SAN-based storage systems typically export a single logical unit number (LUN) shared across multiple virtual machines on a physical server, thereby sharing capacity, performance, RAID levels and data protection methods. This lack of isolation amplifies performance issues and makes managing application performance a tedious, manual and time consuming task. The alternative approach of exporting a single LUN to each virtual machine results in very inefficient use of storage resources and is operationally not feasible in terms of costs.

While server virtualization adds flexibility and scalability, it also exposes an issue with traditional storage system design with rigid storage layers. Resources in current datacenters may be reconfigured from time to time depending on the changing requirements of the applications used, performance issues, reallocation of resources, and other reasons. A configuration change workflow typically involves creating a ticket, notifying IT staff, and deploying personnel to execute the change. The heavy manual involvement can be very challenging and costly for large scale data centers built on inflexible infrastructures. The rigid RAID and storage virtualization layers of traditional storage systems makes it difficult to reuse storage resources. Reusing storage resources require deleting all virtual disks, storage virtualization layers and RAID arrays before the physical disk resources can be reconfigured. Planning and executing storage resource reallocation becomes a manual and labor intensive process. This lack of flexibility also makes it very challenging to support applications that require self-provisioning and elasticity, e.g. private and hybrid clouds.

Within the storage tier, additional challenges arise from heterogeneous storage systems from multiple vendors on the same network. This results in the need to manage isolated silos of storage capacity using multiple management tools. Isolated silos means that excess storage capacity in one storage system cannot flexibly be shared with applications running off storage capacity on a different storage system resulting in inefficient storage utilization, as well as, operational complexity. Taking advantage of excess capacity in a different storage system requires migrating data.

Previous solutions attempt to address the issues of performance, flexibility, manageability and utilization at the storage tier through a storage hypervisor approach. It should be noted that storage hypervisors operate as a virtual layer across multiple heterogeneous storage systems on the SAN to improve their availability, performance and utilization. The storage hypervisor software virtualizes the individual storage resources it controls to create one or more flexible pools of storage capacity. Within a SAN based infrastructure, storage hypervisor solutions are delivered at the server, network and storage tier. Server based solutions include storage hypervisor delivered as software running on a server as sold by Virsto (US 2010/0153617), e.g. Virsto for vSphere. Network based solutions embed the storage hypervisor in a SAN appliance as sold by IBM, e.g. SAN Volume Controller and Tivoli Storage Productivity Center. Both types of solutions abstract heterogeneous storage systems to alleviate management complexity and operational costs but are dependent on the presence of a SAN and on data redundancy, e.g. RAID protection, delivered by storage systems. Storage hypervisor solutions are also delivered within the storage controller at the storage layer as sold by Hitachi (U.S. Pat. No. 7,093,035), e.g. Virtual Storage Platform. Storage hypervisors at the storage system abstract certain third party storage systems but not all. While data redundancy is provided within the storage system, the solution is still dependent on the presence of a SAN. There is no comprehensive solution that eliminates the complexity and cost of a SAN, while providing the manageability, performance, flexibility and data protection in a single solution.

### SUMMARY OF THE INVENTION

A storage hypervisor having a software defined storage controller (SDSC) of the present invention provides for a comprehensive set of storage control and monitoring functions, through virtualization to decide the placement of data and orchestrate workloads. The storage hypervisor manages functions such as availability, automated provisioning, data protection and performance acceleration services. A module of the storage hypervisor, the SDSC running as a software driver on the server replaces the storage controller function within a storage system on a SAN based infrastructure. A module of the SDSC, the distributed disk file system module (DFS) virtualizes physical disks into building blocks called chunks which are regions of physical disks. The novel approach of the SDSC enables the complexity and cost of the SAN infrastructure and SAN attached storage systems to be eliminated while greatly increasing the flexibility of a data center infrastructure. The unique design of the SDSC also enables a SAN free infrastructure without sacrificing the performance benefits of a traditional SAN based infrastructure. Modules of the SDSC, the storage virtualization module (SV) and the data redundancy module (DR) combine to eliminate the need for a physical RAID layer. The elimination of the physical RAID layer enables de-allocated virtual disks to be available immediately for reuse without first having to perform complicated and time consuming steps to release physical storage resources. The elimination of the physical RAID layer also enables the storage hypervisor to maximize configuration flexibility for virtual disks. This configuration flexibility enables the storage hypervisor to select and optimize the combination of storage resources, data protection levels and data services to efficiently achieve the performance, availability and cost objectives of each application. With the ability to present uniform virtual devices and services from dissimilar and incompatible hardware in a generic way, the storage hypervisor makes the hardware interchangeable. This enables continuous replacement and substitution of the underlying physical storage to take place without altering or interrupting the virtual storage environment that is presented.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a high-level block diagram illustrating a prior art system based on a storage area network infrastructure;

FIG. 2 is a block diagram illustrating prior art example of a storage system presenting a virtual disk which is shared by multiple virtual machines on a physical server;

FIG. 3 is another high-level block diagram illustrating a prior art system based on a storage area network infrastructure wherein the storage hypervisor is located in the server;

FIG. 4 is yet another high-level block diagram illustrating a prior art system based on a storage area network infrastructure wherein the storage hypervisor is located in the network;

FIG. 5 is yet still another high-level block diagram illustrating a prior art system based on a storage area network infrastructure wherein the storage hypervisor is located in the storage system;

FIG. 6 is a high-level block diagram illustrating a system having a storage hypervisor located in the server with the network tier simplified and the storage tier removed according to one embodiment of the invention;

FIG. 7 is a high-level block diagram illustrating modules within the storage hypervisor and both storage hypervisors configured for cache mirroring according to one embodiment of the invention;

FIG. 8 is a block diagram illustrating modules of a software defined storage controller according to one embodiment of the invention;

FIG. 9 is a block diagram illustrating an example of chunk (region of a physical disk) allocation for a virtual disk across nodes in a cluster (set of nodes that share certain physical disks on a communications network) and a direct mapping function of the virtual machine to a virtual disk according to one embodiment of the invention.

FIG. 10 is a diagram illustrating an example of a user screen interface for automatically configuring and provisioning virtual machines according to one embodiment of the invention;

FIG. 11 is a diagram illustrating an example of a user screen interface for automatically configuring and provisioning virtual disks according to one embodiment of the invention; and

FIG. 12 is a diagram illustrating an example of a user screen interface for monitoring and managing the health and performance of virtual machines according to one embodiment of the invention.

### DETAILED DESCRIPTION OF THE PREFERRED EMBODIMENTS

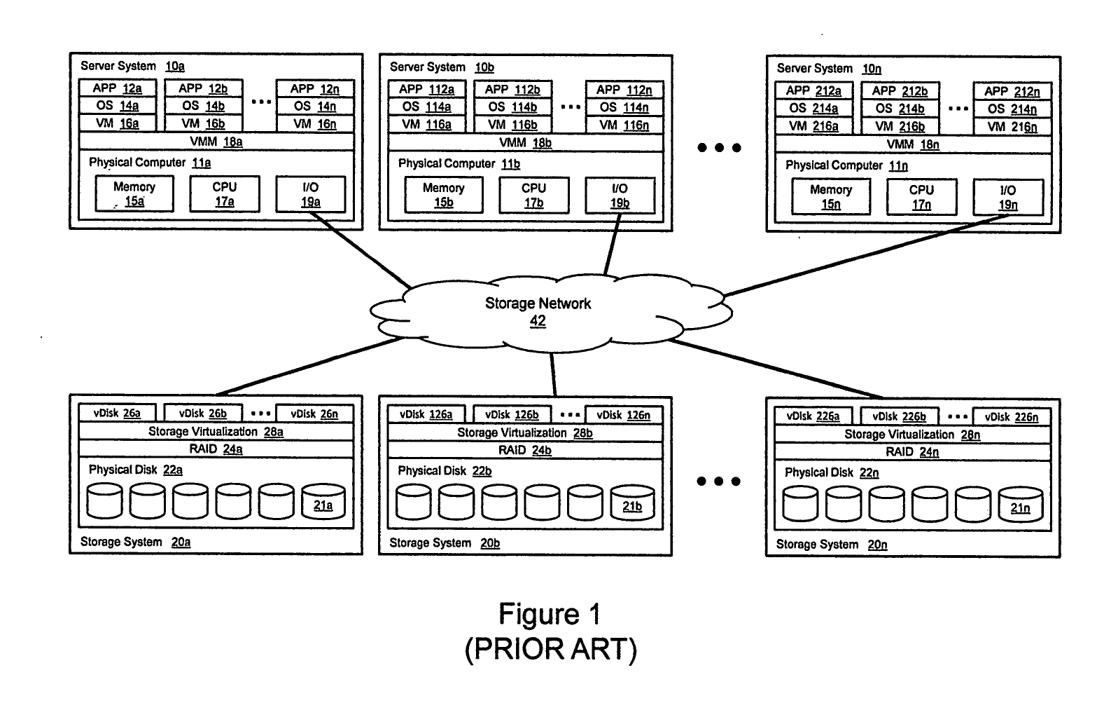

Referring to FIGS. 1, 3, 4 and 5 there is shown a high-level block diagram illustrating prior art systems based on a SAN infrastructure. The environment comprises multiple servers 10a-n and storage systems 20a-n. The servers are connected to the storage systems 20a-n via a storage network 42, such as a storage area network (SAN), Internet Small Computer System Interface (iSCSI), Network-attached storage (NAS) or other storage networks known to those of ordinary skill in the software or computer arts. Storage systems 20a-n comprises one or more homogeneous or heterogeneous computer storage devices.

Turning once again to FIGS. 1, 3, 4 and 5 (prior art), the servers 10a-n have corresponding physical computers 11a-n each which may incorporate such resources as CPUs 17a-n, memory 15a-n and I/O adapters 19a-n. The resources of the physical computers 11a-n are controlled by corresponding virtual machine monitors (VMMs) 18a-n that create and control multiple isolated virtual machines (VMs) 16a-n, 116a-n and 216a-n. VMs 16a-n, 116a-n and 216a-n have guest operating system (OS) 14a-n, 114a-n and 214a-n and one or more software applications 12a-n, 112a-n and 212a-n. Each VM 16a-n, 116a-n and 216a-n has one or more block devices (not shown) which are partitions of virtual disks (vDisks) 26a-n, 126a-n and 226a-n presented across the SAN by storage systems 20a-n. The storage systems 20a-n has physical storage resources such as physical disks 22a-n and incorporates Redundant Array of Independent Disks (RAID) 24a-n to make stored data redundant. The storage systems 20a-n typically allocate one or more physical disks 22a-n as spare disks 21a-n for rebuild operations in event of a physical disk 22a-n failure. The storage systems 20a-n has corresponding storage virtualization layers 28a-n that provide virtualization and storage management functions to create vDisks 26a-n, 126a-n and 226a-n. The storage systems 20a-n selects one or more vDisks 26a-n, 126a-n and 226a-n and present them as logical unit numbers (LUNs) to servers 10a-n. The LUN is recognized by an operating system as a disk.

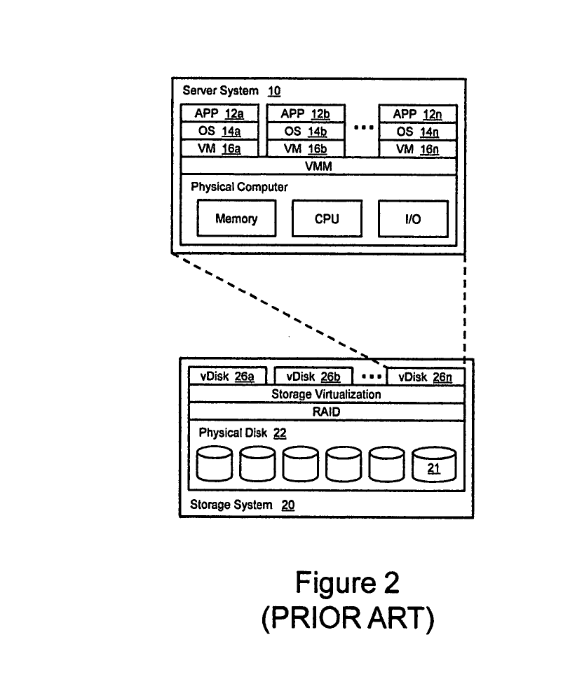

Referring now to FIG. 2 is a high-level block diagram illustrating prior art example of a storage system 20 presenting vDisks 26a-n to a server 10. The vDisks 26a-n is an abstraction of the underlying physical disks 22 within the storage system 20. Each VM 16a-n has one or more block devices (not shown) which are partitions of the vDisk 26a-n presented to the server 10. Since the vDisk 26a-n provides shared storage to the VMs 16a-n, and by extension to corresponding guest OS 14a-n and application 12a-n, the block devices (not shown) for each VM 16a-n, guest OS 14a-n and application 12a-n consequentially share the same capacity, the same performance, the same RAID levels and the same data service policies associated with vDisk 26a-n.

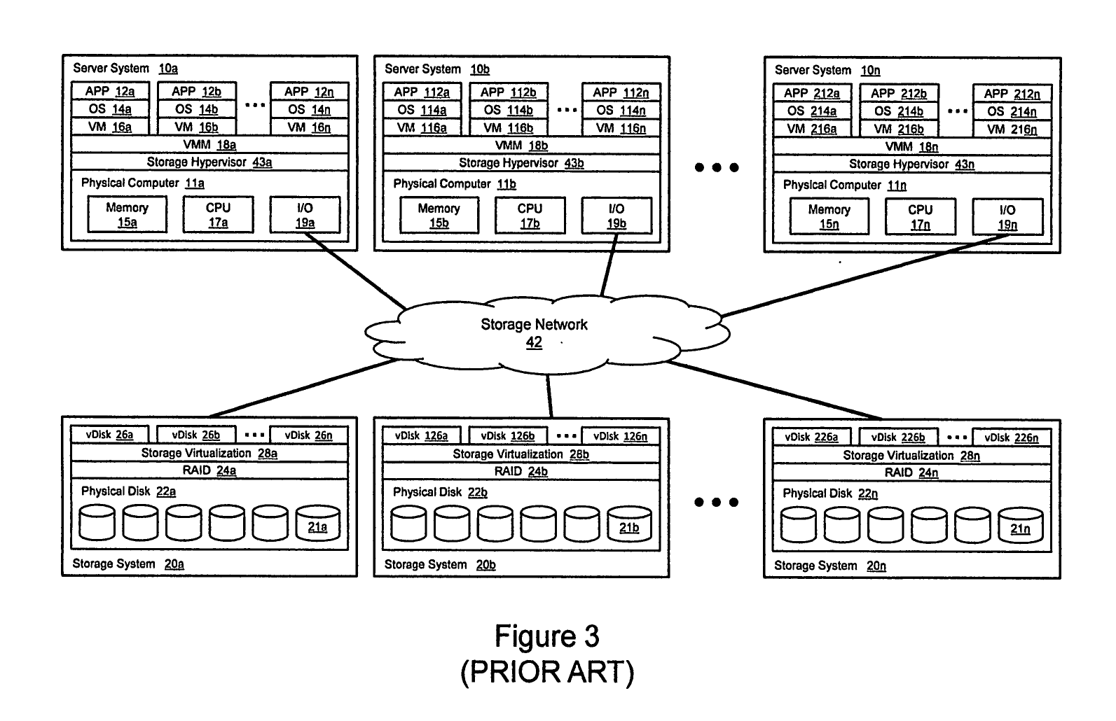

Referring now to FIG. 3 there is shown a high-level block diagram illustrating a prior art system based on SAN infrastructure wherein the storage hypervisor 43a-n is located in the server 10a-n. The storage hypervisor 43a-n provide virtualization and management services for a subset or all of the storage systems 20a-n on storage network 42 and typically rely on storage systems 20a-n to provide data protection services.

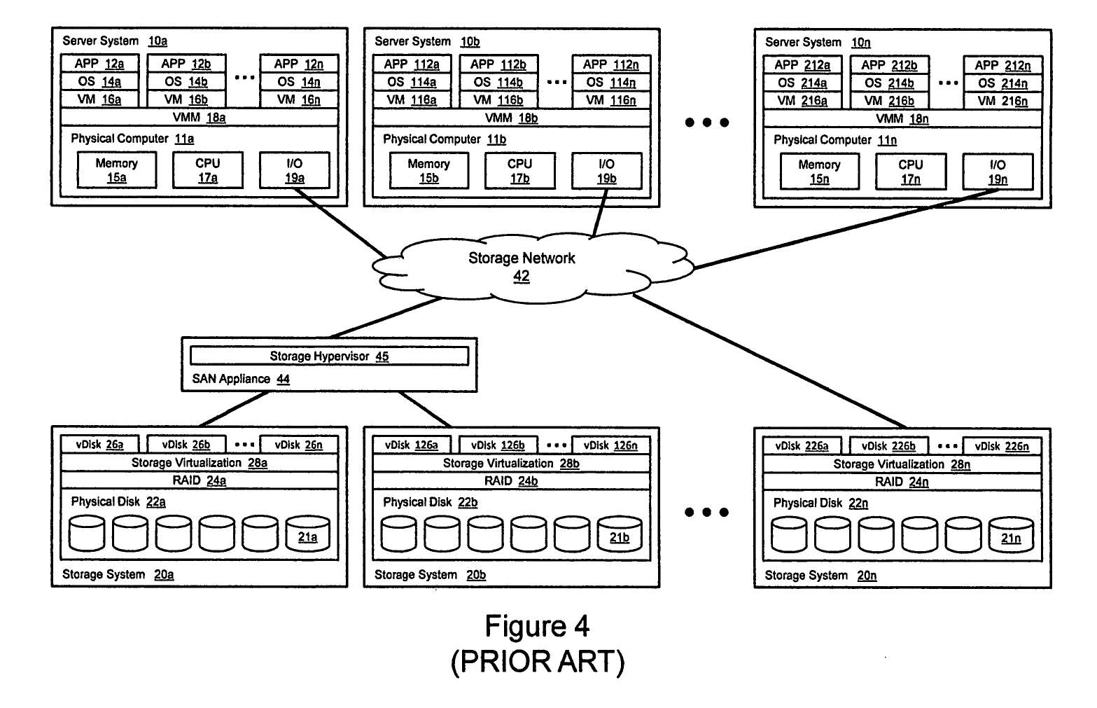

Referring now to FIG. 4 there is shown a high-level block diagram illustrating a prior art system based on SAN infrastructure wherein the storage hypervisor 45 is located in a SAN appliance 44 on storage network 42. The storage hypervisor 45 provides virtualization and management services for a subset or all of the storage systems 20a-n on storage network 42 and typically rely on storage systems 20a-n to provide data protection services.

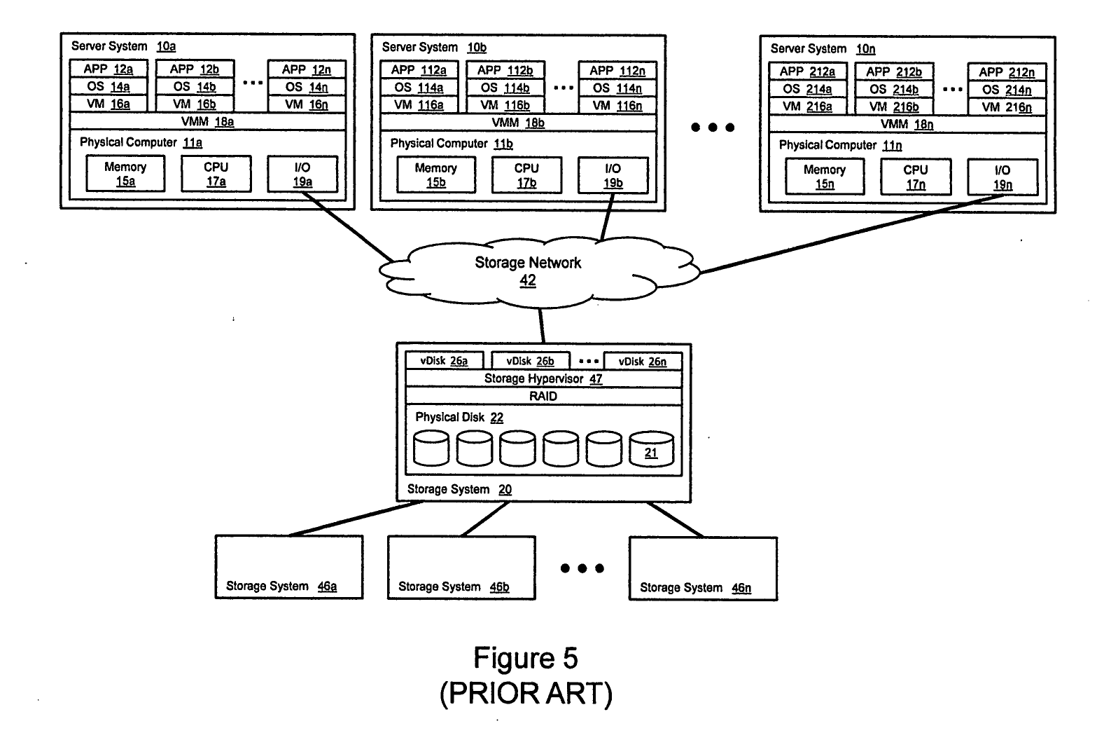

Referring now to FIG. 5 there is shown a high-level block diagram illustrating a prior art system based on SAN infrastructure wherein the storage hypervisor 47 is located in a storage system 20 on storage network 42. The storage hypervisor 47 provides virtualization and management services for internal physical disks 22 and for external storage systems 46a-n directly attached to storage system 20.

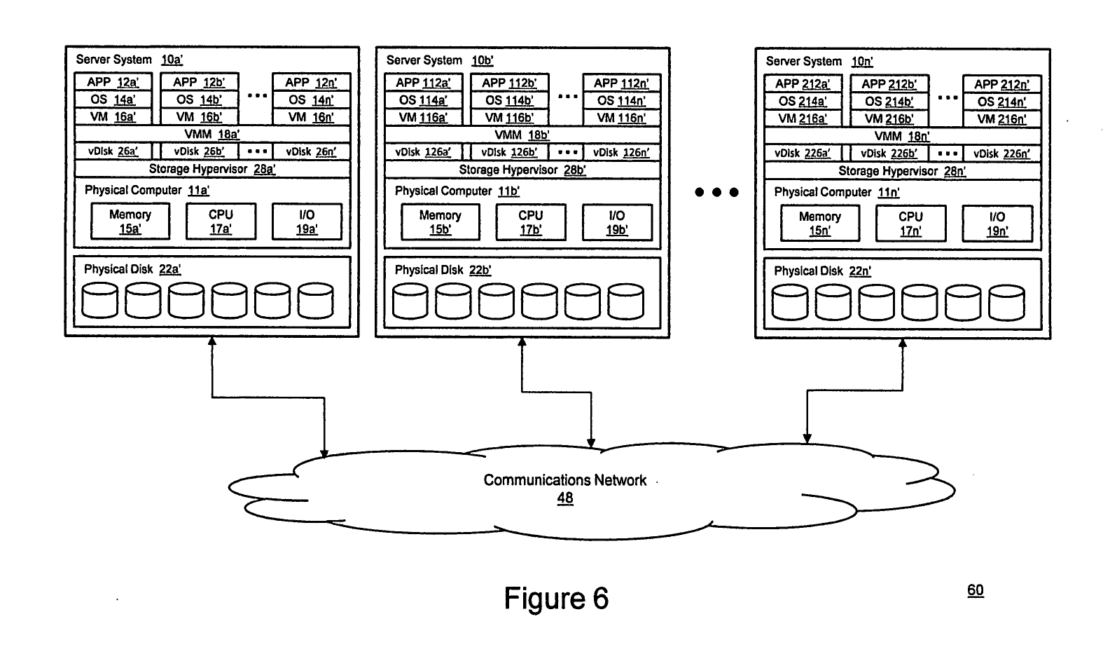

Referring now to FIG. 6 is a block diagram illustrating a system having our storage hypervisors 28a′-n′ located in servers 10a′-n′ with the network tier simplified and the storage tier removed according to one embodiment of the invention. The environment comprises multiple servers (nodes) 10a′-n′ connected to each other via communications network 48, such as Ethernet, InfiniBand and other networks known to those of ordinary skills in the art. An embodiment of the invention may split the communications network 48 into a client (not shown) to server 10a′-n′ network and a server 10a′-n′ to server 10a′-n′ network by utilizing one or more network adapters on the servers 10a′-n′. Such an embodiment may also have a third network adapter dedicated to system management. Communications network 48 may have one or more clusters which are sets of nodes 10a′-n′ that share certain physical disks 28a′-n′ on communications network 48. In this invention, our storage hypervisor 28a′-n′ virtualizes certain physical disks 28a′-n′ on communications network 48 through a distributed disk file system (as will be described below). Virtualizing the physical disks 28a′-n′ and using the resulting chunks (as will be described below) as building blocks enables the invention to eliminate the need for spare physical disks 21a-n (FIG. 1) as practiced in prior art. Our storage hypervisor 28a′-n′ also incorporates the functions of a hardware storage controller as software running on nodes 10a′-n′. The invention thus enables the removal of the SAN and consolidates the storage tier into the server tier resulting in dramatic reduction in the complexity and cost of the system 60.

Also in FIG. 6, the nodes 10a′-n′ have corresponding physical computers 11a′-n′ which incorporate such resources as CPUs 17a′-n′, memory 15a′-n′, I/O adapters 19a′-n′ and physical disks 22a′-n′. The CPUs 17a′-n′, memory 15a′-n′ and I/O adapters 19a′-n′ resources of the physical computers 11a′-n′ are controlled by corresponding virtual machine monitors (VMMs) 18a′-n′ that create and control multiple isolated virtual machines (VMs) 16a′-n′, 116a′-n′ and 216a′-n′. VMs 16a′-n′, 116a′-n′ and 216a′-n′ have guest OS 14a′-n′, 114a′-n′ and 214a′-n′ and one or more software applications 12a′-n′, 112a′-n′ and 212a′-n′. Nodes 10a′-n′ run corresponding storage hypervisors 28a′-n′. The physical disks 22a′-n′ resources of physical computers 11a′-n′ are controlled by storage hypervisors 28a′-n′ that create and control multiple vDisks 26a′-n′, 126a′-n′ and 226a′-n′. The storage hypervisors 28a′-n′ play a complementary role to the VMMs 18a′-n′ by providing isolated vDisks 26a′-n′, 126a′-n′ and 226a′-n′ for VMs 16a′-n′, 116a′-n′ and 216a′-n′ which are abstractions of the physical disks 22a′-n′. For each vDisk 26a′-n′, 126a′-n′ and 226a′-n′, the storage hypervisor 28a′-n′ manages a mapping list (as will be described below) that translates logical addresses in an input/output request from a VM 16a′-n′, 116a′-n′ and 216a′-n′ to physical addresses on underlying physical disks 22a′-n′ in the communications network 48. To create vDisks 26a′-n′, 126a′-n′ and 226a′-n′, the storage hypervisor 28a′-n′ requests unallocated storage chunks (as will be described below) from one or more nodes 10a′-n′ in the cluster. By abstracting the underlying physical disks 22a′-n′ and providing storage management and virtualization, data availability and data services in software, the storage hypervisor 28a′-n′ incorporates functions of storage systems 20a-n (FIG. 1) within physical servers 10a′-n′. Adding new nodes 10a′-n′ adds another storage hypervisor 28a′-n′ to process input/output requests from VM 16a′-n′, 116a′-n′ and 216a′-n′. The invention thus enables performance of the storage hypervisor 28a′-n′ to scale linearly as new nodes 10a′-n′ are added to the system 60. By incorporating the functions of storage systems 20a-n (FIG. 1) within physical servers 10a′-n′, the storage hypervisor 28a′-n′ directly presents local vDisks 26a′-n′, 126a′-n′ and 226a′-n′ to VMs 16a′-n′, 116a′-n′ and 216a′-n′ within nodes 10a′-n′. This invention therefore eliminates the SAN 42 (FIG. 1) as well as the network components needed to communicate between the servers 10a-n (FIG. 1) and the storage systems 20a-n (FIG. 1), such as SAN switches, host bus adapters (HBAs), device drivers for HBAs, and special protocols (e.g. SCSI) used to communicate between the servers 10a-n (FIG. 1) and the storage systems 20a-n (FIG. 1). The result is higher performance and lower latency for data reads and writes between the VMs 16a′-n′, 116a′-n′ and 216a′-n′ and vDisks 26a′-n′, 126a′-n′ and 226a′-n′ within nodes 10a′-n′.

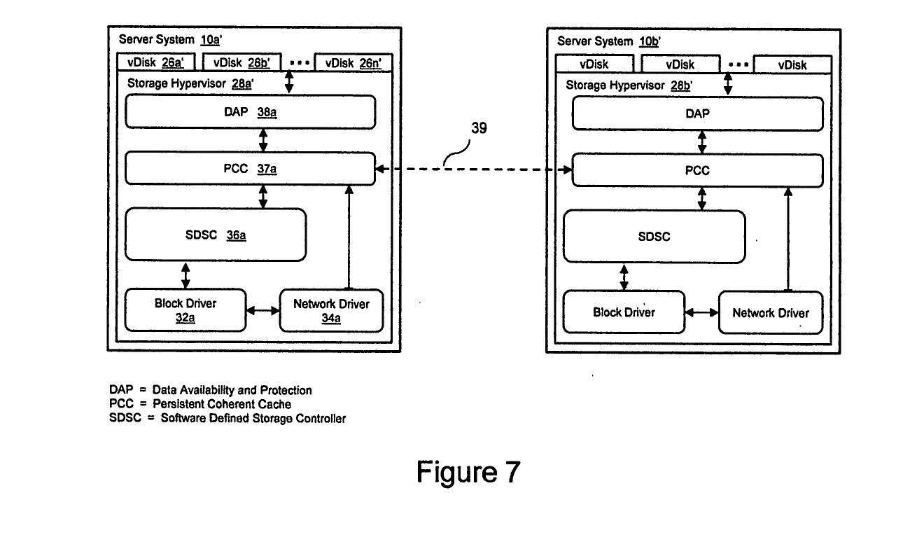

FIG. 7 is a high-level block diagram illustrating modules within storage hypervisors 28a′ and 28b′ and both storage hypervisors 28a′ and 28b′ configured for cache mirroring according to one embodiment of the invention. In this invention, my storage hypervisor 28a′ comprises a data availability and protection module (DAP) 38a, a persistent coherent cache (PCC) 37a, a software defined storage controller (SDSC) 36a, a block driver 32a and a network driver 34a. Storage hypervisors 28a′ and 28b′ run on corresponding nodes 10a′ and 10b′. Storage hypervisor 28a′ presents the abstraction of physical disks 22a′-n′ (FIG. 6) as multiple vDisks 26a′-n′ through a block device interface to VMs 16a′-n′, 116a′-n′ and 216a′-n′ (FIG. 6).

Also in FIG. 7, DAP 38a provides data availability services to vDisk 26a′-n′. The services include high availability services to prevent interrupted application operation due to VM 16a′-n′, 116a′-n′ and 216a′-n′ (FIG. 6) or node 10a′ failures. Snapshot services in DAP 38a provide protection against logical data corruption through point in time copies of data on vDisks 26a′-n′. Replication services in DAP 38a provide protection against site failures by duplicating copies of data on vDisks 26a′-n′ to remote locations or availability zones. DAP 38a provides encryption services to protect data against authorized access. Deduplication and compression services are also provided by DAP 38a to increase the efficiency of data storage on vDisks 26a′-n′ and minimize the consumption of communications network 48 (FIG. 6) bandwidth. The data availability and protection services may be automatically configured and/or manually configured through a user interface. Data services in DAP 38a may also be configured programmatically through a programming interface.

Also in FIG. 7, PCC 37a performs data caching on input/output requests from VMs-n′, 116a′-n′ and 216a′-n′ (FIG. 6) to enhance system responsiveness. The data may reside in different tiers of cache memory, including server system memory 15a′-n′ (FIG. 6), physical disks 22a′-n′ or memory tiers within physical disks 22a′-n′. Data from input/outputs requests are initially written to cache memory. The length of time data stays in cache memory is based on information gathered from analysis of input/output requests from VMs 16a′-n′, 116a′-n′ and 216a′-n′ (FIG. 6) and from system input. System input include information such as application type, guest OS, file system type, performance requirements or VM priority provided during creation of the VM 16a′-n′, 116a′-n′ and 216a′-n′ (FIG. 6). The information collected enables PCC 37a to perform application aware caching and efficiently enhance system responsiveness. Software modules of the PCC 37a may run on CPU 17a′-n′ resources on the nodes 10a′-n′ and/or within physical disks 22a′-n′. There are some data called metadata (not shown) that are used to define ownership, to provide access, to control and to recover vDisks 26a′-n′. Data for write requests to vDisks 26a′-n′ and metadata changes for vDisks 26a′-n′ on node 10a′ are mirrored by PCC 37a through an interlink 39 across the communications network 48 (FIG. 6). The mirrored metadata provide the information needed to rapidly recover VMs 16a′-n′, 116a′-n′ and 216a′-n′ (FIG. 6) for operation on any node 10a′-n′ in the cluster in the event of VM 16a′-n′, 116a′-n′ and 216a′-n′ or node 10a′-n′ failures. The ability to rapidly recover VMs 16a′-n′, 116a′-n′ and 216a′-n′ (FIG. 6) enable high availability services to support continuous operation of applications 12a′-n′, 112a′-n′ and 212a′-n′ (FIG. 6).

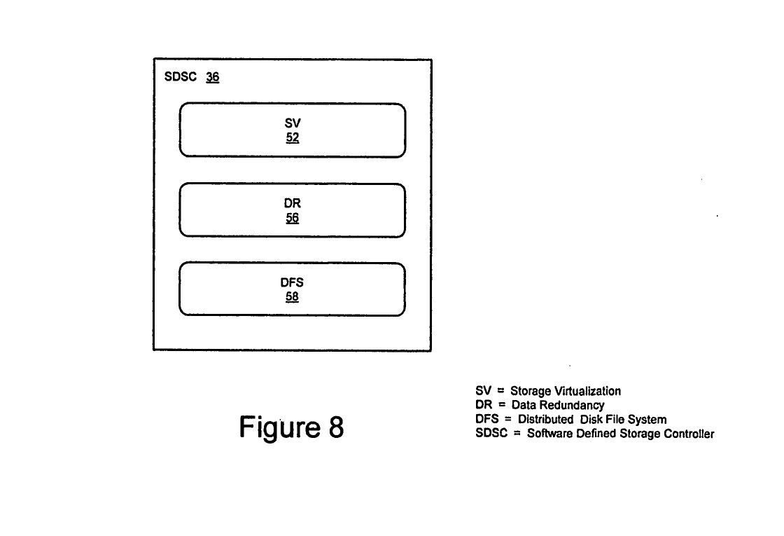

Also in FIG. 7, SDSC 36a receives input/output requests from PCC 37a. SDSC 36a translates logical addresses in input/output requests to physical addresses on physical disks 22a′-n′ (FIG. 6) and reads/writes data to the physical addresses. The SDSC 36a is further described in FIG. 8. The block driver 32a reads from and/or writes to storage chunks (as will be described below) based on the address space translation from SDSC 36a. Input/output requests to remote nodes 10a′-n′ (FIG. 6) are passed through network driver 34a.

FIGS. 6 and 8 contain a block diagram illustrating modules of the SDSC 36 according to one embodiment of the invention. The SDSC 36 comprises a storage virtualization module (SV) 52, a data redundancy module (DR) 56 and a distributed disk file system module (DFS) 58.

Also in FIGS. 6, 8 and 9, the DFS 58 module virtualizes and enables certain physical disk resources 22a′-n′ in a cluster to be aggregated, centrally managed and shared across the communications network 48. The DFS 58 implements metadata (not shown) structures to organize physical disk resources 22a′-n′ of the cluster into chunks 68 of unallocated virtual storage blocks. The metadata (not shown) are used to define ownership, to provide access, to control and to perform recovery on vDisks 26a′-n′, 126a′-n′ and 226a′-n′. The DFS 58 module supports an negotiated allocation scheme utilized by nodes 10a′-n′ to request and dynamically allocate chunks 68 from any node 10a′-n′ in the cluster. Chunks 68 that have been allocated to a node 10a′-n′ are used as building blocks to create corresponding vDisks 26a′-n′, 126a′-n′ and 226a′-n′ for the node 10a′-n′. By virtualizing physical disks 22a′-n′ into virtual building blocks, the DFS 58 module enables elastic usage of chunks 68. Chunks 68 which have been allocated, written to and then de-allocated, may be immediately erased and released for reuse. This elasticity of chunk 68 allocation/de-allocation enables dynamic storage capacity balancing across nodes 10a′-n′. Request for new chunks 68 may be allocated from nodes 10a′-n′ which have more available capacity. The newly allocated chunks 68 are used to physically migrate data to the destination node 10a′-n′. On completion of the data migration, chunks 68 from the source node 10a′-n′ may be immediately released and added to the available pool of storage capacity. The elasticity extends to metadata management in the DFS 58 module. vDisks 26a′-n′, 126a′-n′ and 226a′-n′ may be quickly migrated without data movement through metadata transfer and metadata update of vDisk 26a′-n′, 126a′-n′ and 226a′-n′ ownership. With this approach, the DFS 58 module supports workload balancing among nodes 10a′-n′ for CPU 17a′-n′ resources and input/output requests load balancing across nodes 10a′-n′. The DFS 58 module supports nodes 10a′-n′ and physical disks 22a′-n′ to be dynamically added or removed from the cluster. New nodes 10a′-n′ or physical disks 22a′-n′ added to the cluster are automatically registered by the DFS 58 module. The physical disks 22a′-n′ added are virtualized and the DFS 58 metadata (not shown) structures are updated to reflect the added capacity.

Also in FIGS. 6, 8 and 9, the SV 52 module presents a block device interface and performs translation of logical block addresses from input/output requests to logical addresses on chunks 68. The SV 52 manages the address translation through a mapping list 23. The mapping list 23 is used by the SV 52 module to logically concatenate chunks 68 and presents them as a contiguous virtual block storage device called a vDisk 26a′-n′, 126a′-n′ and 226a′-n′ to VMs 16a′-n′, 116a′-n′ and 216a′-n′. The SV 52 module enables vDisk 26a′-n′, 126a′-n′ and 226a′-n′ to be created, expanded or deleted on demand automatically and/or configured through a user interface. Created vDisks 26a′-n′, 126a′-n′ and 226a′-n′ are visible on communications network 48 and may be accessed by VMs 16a′-n′, 116a′-n′ and 216a′-n′ in the system 60 that are granted access permissions. A reservation protocol is utilized to negotiate access to vDisks 26a′-n′, 126a′-n′ and 226a′-n′ to maintain data consistency, privacy and security. vDisks 26a′-n′, 126a′-n′ and 226a′-n′ ownership are assigned to individual nodes 10a′-n′. Only nodes 10a′-n′ with ownership of the vDisk 26a′-n′, 126a′-n′ and 226a′-n′ can accept and process input/output requests and read/write data to chunks 68 on physical disks 22a′-n′ which are allocated to the vDisk 26a′-n′, 126a′-n′ and 226a′-n′. The vDisk 26a′-n′, 126a′-n′ and 226a′-n′ operations are also configured programmatically through a programming interface. SV 52 also manages input/output performance metrics (latency, IOPS, throughput) per vDisk 26a′-n′, 126a′-n′ and 226a′-n′. Any available chunk 68 from any node 10a′-n′ in the cluster can be allocated and utilized to create a vDisk 26a′-n′, 126a′-n′ and 226a′-n′. De-allocated chunks 68 may be immediately erased and available for reuse on new vDisks 26a′-n′, 126a′-n′ and 226a′-n′ without complicated and time consuming steps to delete virtual disks 26a-n, 126a-n and 226a-n (FIG. 1), storage virtualization 28a-n (FIG. 1) layers and RAID 24a-n layers (FIG. 1) layers as practiced in prior art. The invention enables this elasticity by adding data redundancy (as will be described below) as data are written to chunks 68. The invention thus eliminates the need for rigid physical RAID 24a-n layer (FIG. 1) as practiced in prior art. The SV 52 module supports a thin provisioning approach in creating and managing vDisks 26a′-n′, 126a′-n′ and 226a′-n′. Chunks 68 are not allocated and added to the mapping list 23 for a vDisk 26a′-n′, 126a′-n′ and 226a′-n′ until a write request is received to save data to the vDisk 26a′-n′, 126a′-n′ and 226a′-n′. The thin provisioning approach enables logical storage resources to be provisioned for applications 12a′-n′, 112a′-n′ and 212a′-n′ without actually committing physical disk 22a′-n′ capacity. The invention enables the available physical disk 22a′-n′ capacity in the system 60 to be efficiently utilized only for actual written data instead of committing physical disk 22a′-n′ capacity which may or may not be utilized by applications 12a′-n′, 112a′-n′ and 212a′-n′ in the future.

Also in FIGS. 6, 8 and 9, in the preferred embodiment the DR 56 module provides data redundancy services to protect against hardware failures, such as physical disk 22a′-n′ failures or node 10a′-n′ failures. The DR 56 module utilizes RAID parity and/or erasure coding to add data redundancy. As write requests are received, the write data in the requests are utilized by the DR 56 module to compute parity or redundant data. The DR 56 module writes both the data and the computed parity or redundant data to chunks 68 which are mapped to physical addresses on physical disks 22a′-n′. In the event of hardware failures such as media errors on physical disks 22a′-n′, physical disk 22a′-n′ failures or node 10a′-n′ failures, redundant data is utilized to calculate and rebuild the data on failed physical disks 22a′-n′ or nodes 10a′-n′. The rebuilt data are written to new chunks 68 allocated for the rebuild operation. Since the size of chunks 68 is much smaller than the capacity of physical disks 22a′-n′, the time to compute parity and write the rebuilt data for chunks 68 is proportionately shorter. Compared to prior art, the invention significantly shortens the time to recover from hardware failures. By shortening the time for the rebuild operation, the invention greatly reduces the chance of losing data due to a second failure occurring prior to the rebuilding operation completing. By adding data redundancy to chunks 68, the invention also eliminates the need for spare physical disks 21a-n (FIG. 1) practiced in prior art. Compared to prior art, the invention further shortens the rebuilding time by enabling rebuilding operations on one or more nodes 10a′-n′ onto one or more physical disks 22a′-n′. The DR 56 module on each node 10a′-n′ performs the rebuilding operation for corresponding vDisks 26a′-n′, 126a′-n′ and 226a′-n′ on the node 10a′-n′. Since the replacement chunk 68 for the rebuild operation may be allocated from one or more physical disks 22a′-n′, the invention enables the rebuild operation to be performed in parallel on one or more nodes 10a′-n′ onto one or more physical disks 22a′-n′. This is much faster than a storage system 20a-n (FIG. 1) performing a rebuild operation on one spare physical disk 22a-n (FIG. 1) as practiced in prior art. Since the SV 52 module allocates and adds chunks 68 to mapping list 23 on write requests, rebuilding a vDisk 26′ is significantly faster compared to the prior art approach of rebuilding an entire physical disk 22a′-n′ on hardware failures. By utilizing a thin provisioning approach, the rebuilding operation only has to compute parity and rebuild data for chunks 65, 66 and 67 with application data written. The invention encompasses the prior art approach of triple copy for data redundancy and provides a much more efficient redundancy approach. For example in the triple copy approach, chunks 65, 66 and 67 have identical data written. With this approach, only one third of the capacity is actually used for storing data. In one embodiment of the invention, a RAID parity approach enables chunks 65, 66 and 67 to be written with both data and computed parity. Both the data and computed parity are distributed among chunks 65, 66 and 67. Compared to the triple copy approach, the RAID parity approach enables twice as much data to be written to chunks 65, 66 and 67. The efficiency of data capacity can be further improved by increasing the number of chunks 68 used to distribute data. By utilizing RAID parity and/or erasure coding, the DR 56 module enables significantly more efficient data capacity utilization compared to the triple copy approach practiced in prior art. Since vDisks 26a′-n′, 126a′-n′ and 226a′-n′ are created from chunks 68 allocated and accessed across the communications network 48, the network bandwidth is also efficiently utilized compared to prior art practices. The DR 56 module enables the data redundancy type to be selectable per vDisk 26a′-n′, 126a′-n′ and 226a′-n′. The data redundancy type may be automatically and/or manually configured through a user interface. The data redundancy type is also configurable programmatically through a programming interface.

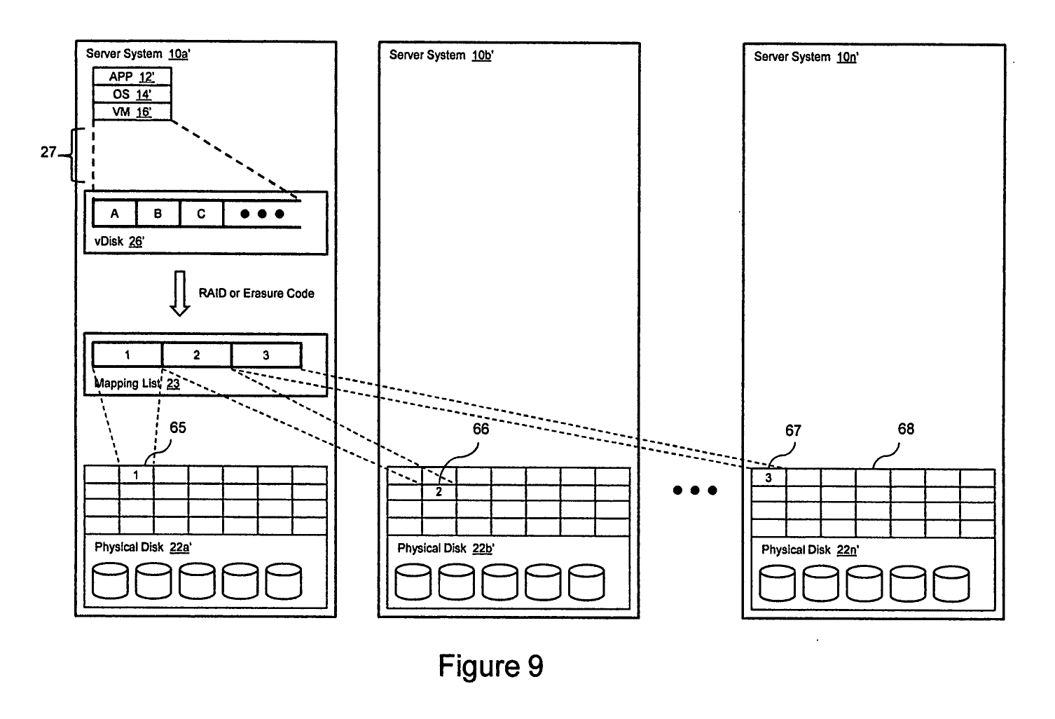

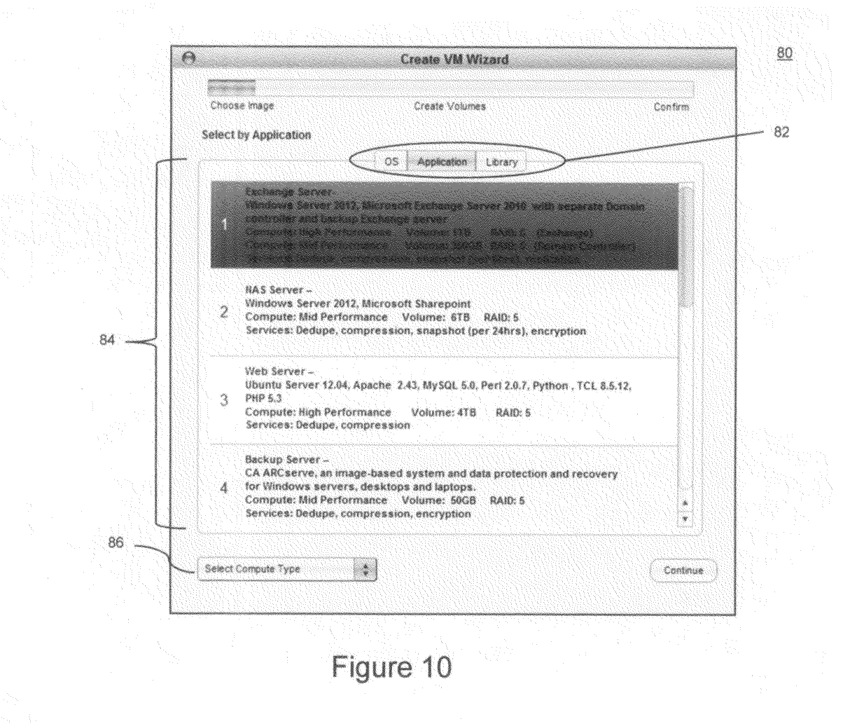

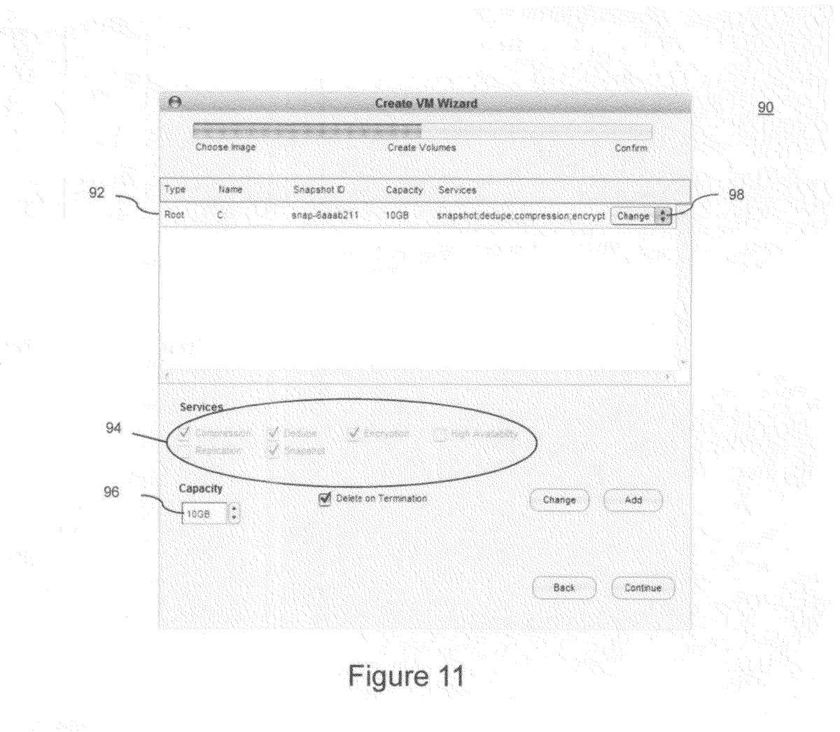

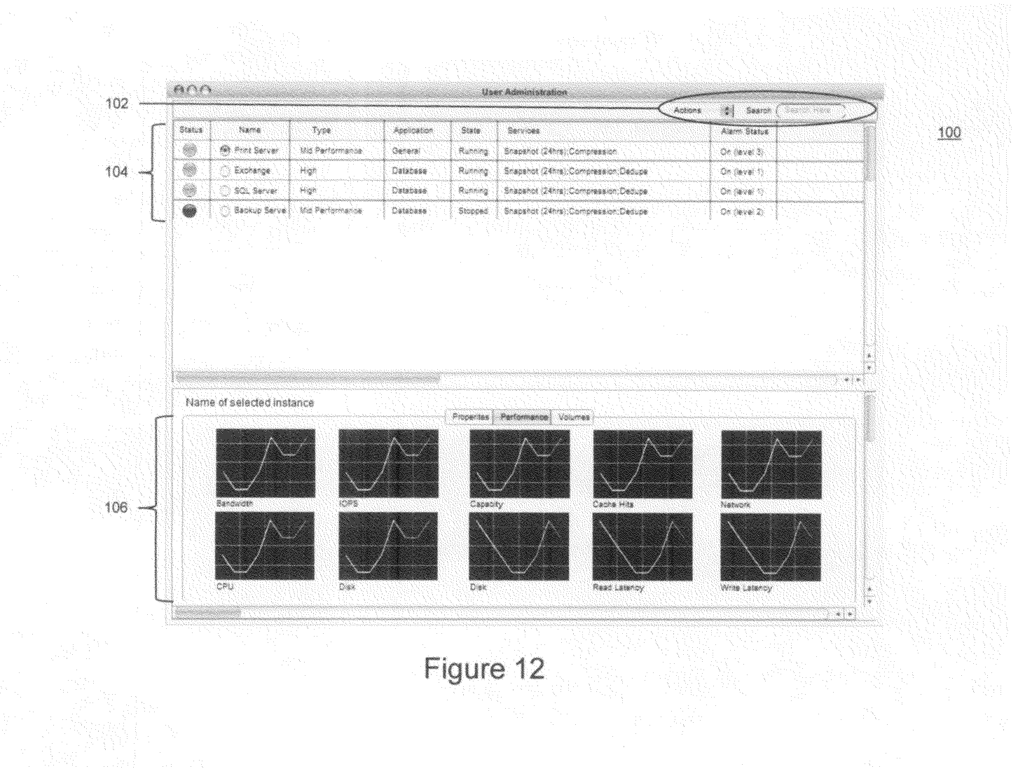

FIG. 9 is a diagram illustrating an example of chunk (region of a physical disk) allocation for a vDisk 26′ across nodes 10a′-n′ in a cluster (set of nodes that share certain physical disks on a communications network) and a direct mapping function 27 of the virtual machine 16′ to a virtual disk 26′ and consequently to chunks 65, 66 and 67 on physical disks 22a′-n′ according to one embodiment of the invention. One vDisk 26′ with three allocated chunks 65, 66 and 67 is illustrated for purposes of simplification. The SV 52 (FIG. 8) module allocates chunks 68 from nodes 10a′-n′ in the cluster through an negotiated allocation scheme. A mapping list 23 is used by the SV 52 (FIG. 8) module to logically concatenate chunks 68 and presents them as a contiguous virtual block storage device called a vDisk 26′ to VM 16′. Write data from VM 16′ to vDisk 26′ are used by the DR 56 module (FIG. 8) to compute parity and add data redundancy. The physical addresses for the write data and computed parity or redundant data are translated from the mapping list 23. The write data from VM 16′ and the computed parity or redundant data are written by the DR 56 module (FIG. 8) to translated addresses for chunks 65, 66 and 67 in mapping list 23. This invention enables the SV 52 module (FIG. 8) to select the data redundancy type independently for each vDisk 26′. In contrast with the consequential sharing of capacity, performance, RAID levels and data service policies of prior art (FIG. 2), the ability to independently select data redundancy type maximizes configuration flexibility and isolation between vDisk 26′. Each vDisk 26′ is provided with the capacity, performance, data redundancy protection and data service policies that matches the needs of the application 12′ corresponding to VM 16′. The configurable performance parameters include the maximum number of input/output operations per second, the priority at which input/output requests for the vDisks 26′ will be processed and the locking of allocated chunks 65, 66 and 67 to the highest performance storage tier, such as SSD. The configurable data service policies include enabling services such as snapshot, replication, encryption, deduplication, compression and data persistence. Services such as snapshot support additional configuration parameters including the time of snapshot, snapshot period and the maximum number of snapshots. Additional configuration parameters for encryption services include the type of encryption. With system input on application type, VM 16′ may be automatically provisioned and managed according to its application 12′ and/or guest OS 14′ unique requirements without impact to adjacent VMs 16a′-n′, 116a′-n′ and 216a′-n′ (FIG. 6). An example of such system input is illustrated in FIGS. 10 and 11 where the user selects the type of application and computing environment they want on their VM 16a′-n′, 116a′-n′ and 216a′-n′ (FIG. 6). The isolation between vDisks 26′ also enables simple performance reporting and tuning for each vDisk 26′ and its corresponding VM 16′, guest OS 14′ and application 12′. Performance demanding VMs 16a′-n′, 116a′-n′ and 216a′-n′ (FIG. 6) generating increased IOPS or throughput may be quickly identified and/or managed. An example of such a user interface and reporting tool is illustrated in FIG. 12. The invention thus provides more valuable information, greater flexibility and a higher degree of control at the VM 16a′-n′, 116a′-n′ and 216a′-n′ (FIG. 6) level compared to the prior art illustrated in FIG. 2.

FIG. 10 is a diagram illustrating an example of a user screen interface 80 for automatically configuring and provisioning VMs 16a′-n′, 116a′-n′ and 216a′-n′ (FIG. 6) according to one embodiment of the invention. The user screen interface 80 may include a number of functions 82 that allow the user to list the computing environment by operating systems, application type or user defined libraries. The user screen interface 80 may include a function 84 that allows the user to select a pre-configured virtual system. A user screen interface 80 may include a function 86 that allows the user to assign the level of computing resource for VMs 16a′-n′, 116a′-n′ and 216a′-n′ (FIG. 6). The computing resources may have different number of processors, processor speeds or memory capacity. Depending on the implementation, the user screen interface 80 may include additional, fewer, or different features than those shown.

FIG. 11 is a diagram illustrating an example of a user screen interface 90 for automatically configuring and provisioning vDisks 26a′-n′, 126a′-n′ and 226a′-n′ (FIG. 6) according to one embodiment of the invention. The user screen interface 90 shows a pre-configured vDisk 92 associated with the application previously selected by the user. A function 98 may include options for the user to change the configuration. The user screen interface 90 shows data services selection 94 automatically configured according to the application previously selected by the user. The user screen interface 90 may include a function 96 that allows the user to change the pre-configured capacity. Depending on the implementation, the user screen interface 90 may include additional, fewer, or different features than those shown.

FIG. 12 is a diagram illustrating an example of a user screen interface 100 for monitoring and managing the health and performance of VMs 16a′-n′, 116a′-n′ and 216a′-n′ (FIG. 6) according to one embodiment of the invention. The user screen interface 100 may include a number of functions 102 for changing the views of the user. The user screen interface 100 may present a view 104 to list the parameters and status of VMs that are assigned to a user account. The user screen interface 100 may include views 106 to present detailed performance metrics to the user. Depending on the implementation, the user screen interface 100 may include additional, fewer, or different features than those shown.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a solid state drive (SSD), a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smailtalk, C++ or the like and conventional procedural programming languages, such as the “C” programming language or programming languages such as assembly language.

Aspects of the present invention are described below with reference to block diagrams of methods, apparatus (systems) and computer program products according to embodiments of the invention. It will be understood that each block of the block diagrams, and combinations of blocks in the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the block diagram block or blocks.

The block diagrams in FIGS. 6 through 13 illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer system having one or more servers each including computer usable program code embodied on a computer usable storage medium, the computer usable program code comprising:
computer usable program code defining a storage hypervisor having one or more software modules, said storage hypervisor being loaded into one or more servers;
one of said software modules being a software defined storage controller module within said storage hypervisor;
said software defined storage controller module determining storage resources of the one or more servers by characterizing type, size, performance and location of said storage resources;
said software defined storage controller module creating virtual disks from said storage resources; and
said software defined storage controller module creating a disk file system stored within said storage resources for providing storage services to one or more said virtual disks.

2. The computer system according to claim 1, wherein said storage hypervisor utilizes a block-based distributed file system with a negotiated allocation scheme for virtual blocks of storage.

3. The computer system according to claim 1, wherein said storage hypervisor includes a distributed storage hypervisor for simultaneously aggregating, managing and sharing said storage resources through a distributed file system.

4. The computer system according to claim 1, wherein said storage hypervisor includes one or more software modules running as an application on physical servers.

5. The computer system according to claim 1, wherein said storage hypervisor includes one or more software modules running within the kernel on physical servers.

6. The computer system according to claim 1, wherein said storage hypervisor includes one or more software modules running within virtual machines on physical servers.

7. The computer system according to claim 1, wherein said storage hypervisor provides both the high data transfer throughput and the low latency of a hardware SAN at lower costs while eliminating the need for SCSI I/O operations between virtual machines and virtual disks.

8. A storage hypervisor loaded into one or more servers, comprising;
a software defined storage controller module;
said software defined storage controller module used for determining storage resources of the one or more servers by characterizing type, size, performance and location of said storage resources; and
said software defined storage controller module creating virtual disks from said storage resources.

9. The storage hypervisor according to claim 8, said storage hypervisor further adding data redundancy to virtual disks through RAID and erasure code services for protecting data against physical disk failures while improving availability.

10. The storage hypervisor according to claim 8, said storage hypervisor further adding data redundancy to virtual disks through RAID and erasure code services for protecting data against node failures while improving availability.

11. The storage hypervisor according to claim 8, wherein the storage hypervisor further de-allocates chunks which are immediately reusable, improving elasticity of the computer system.

12. The storage hypervisor according to claim 8, wherein the storage hypervisor further rebuilds virtual disks when a physical disk fails, said virtual disk rebuilding taking place in parallel on one or more servers and on one or more physical disks resulting in reducing an amount of time required to rebuild a physical disk.

13. The storage hypervisor according to claim 8, wherein the storage hypervisor further rebuilds virtual disks when a node fails, said virtual disk rebuilding taking place in parallel on one or more servers and on one or more physical disks resulting in reducing an amount of time required to rebuild a node.

14. The storage hypervisor according to claim 8, wherein on media errors, fast rebuilds are performed due to smaller size of chunks as compared to physical disks resulting in reducing the probability of data loss due to secondary failures occurring during rebuilding operations.

15. The storage hypervisor according to claim 8, wherein the storage hypervisor further eliminates a need to use spare physical disks to repair broken RAID storage resulting in reducing cost and improving availability.

16. The storage hypervisor according to claim 8, wherein said storage hypervisor includes a persistent, coherent cache that is mirrored across one or more server nodes to improve availability.

17. The storage hypervisor according to claim 8, further includes a persistent, coherent cache that is mirrored across those server nodes having an ability to recover virtual machines and associated virtual disks rapidly on backup nodes by using failover techniques.

18. The storage hypervisor according to claim 8, further includes a persistent, coherent cache that may be optimized for determining whether it resides in system memory, on physical disks or within memory components of physical disks.

19. The storage hypervisor according to claim 8, further includes a persistent, coherent cache that is mirrored across server nodes including an ability to quickly migrate virtual disk ownership through metadata transfer and metadata update of the virtual disk ownership thus balancing workload among server nodes without physical data migration.

20. The storage hypervisor according to claim 8, further comprising:
said storage controller module replacing a physical disk with a physical disk of the same type having a larger capacity wherein replacing said disks are physically hot-swappable, such that an exchange may be done dynamically wherein additional capacity may be fully utilized.

21. The storage hypervisor according to claim 8, further comprising:
said storage controller module replacing a physical disk with a physical disk of different type having a smaller capacity wherein replacing said disks are physically hot-swappable, such that an exchange may be done dynamically wherein additional capacity may be fully utilized.

22. A storage hypervisor loaded into one or more servers, comprising;
a software defined storage controller module;
said software defined storage controller module determining storage resources of the one or more servers by characterizing type, size, performance and location of said storage resources;
said software defined storage controller module creating virtual disks from said storage resources; and
said software defined storage controller module providing selectable data redundancy type independently for each of the said virtual disks.

23. The storage hypervisor according to claim 22, further includes a user selectable feature for selecting capacity, performance, data redundancy type and data service policies for each virtual disk.

24. The storage hypervisor according to claim 22, further includes the ability to select capacity, performance, data redundancy type and data service policies for each virtual disk without affecting other virtual disks.

25. The storage hypervisor according to claim 8, performs fast rebuild of one or more media errors without requiring a physical disk rebuild to extend usage life of physical disk.

26. The storage hypervisor according to claim 8, wherein on media error performs fast rebuilds of small chucks and migrates remaining allocated chunks on physical disk without parity calculations and overhead of extra I/Os.

27. The storage hypervisor according to claim 8, further allowing said virtual disk to be accessed on both the local node and remote nodes at the same time.

28. The storage hypervisor according to claim 8, further using distributed disk file system metadata and mapping list of vDisks to create visual mapping of vDisks onto physical servers, physical disks and virtual blocks to simplify root cause analysis.

29. The storage hypervisor according to claim 22, further including ability for a user to safely self-provision vDisks programmatically or through a graphical user interface.

30. The storage hypervisor according to claim 22 and 24, further including an ability to support one or more different application workloads at the same time.
